(19) United States
(12) Patent Application Publication
(10) Pub. No.: US 2004/0175252 A1
(43) Pub. Date: Sep. 9, 2004

(54) Fastener and washer assembly and method of forming same

(76) Inventor: Richard J. Kurczynski, Eastpointe, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/791,032

(22) Filed: Mar. 2, 2004

Related U.S. Application Data
(60) Provisional application No. 60/451,558, filed on Mar. 3, 2003.

(51) Int. Cl. F16B 39/10

(52) U.S. Cl. 411/120

(57) ABSTRACT

A fastener and washer assembly wherein the washer includes a central planar bearing portion, an opening through the bearing portion, end portions inclined from a plane of the planar bearing portion and elongated openings on opposed sides of the central opening and a fastener having a body portion and a radial flange portion received in the elongated openings, rotatably supporting the fastener on the washer. The method of assembly includes driving the radial flange portion of the fastener against at least one of the inclined end portions of the washer, resiliently biasing the end portion outwardly and receiving the radial flange portion in the elongated openings.

### RELATED APPLICATIONS

This application claims priority to U.S. Provisional application Ser. No. 60/451,558 filed Mar. 3, 2003.

### FIELD OF THE INVENTION

This invention relates to a fastener and washer assembly and method of forming same, wherein the fastener may rotate relative to the washer, but the washer is retained on the fastener.

### BACKGROUND OF THE INVENTION

There are many applications which require a washer located between the head or body of the fastener and a substrate to which the fastener is threadably attached, particularly including mass production applications such as automotive applications, where a torque wrench is used to thread the fastener. At present, a washer may be manually placed between the substrate and the fastener head or body in such applications. However, manual placement of a washer requires a separate step which may also be difficult in certain applications. Alternatively, there are nut and washer assemblies available on the market, wherein the washer is rotatably supported on a specially designed nut in a groove in an annular body portion of the nut. A fastener and washer assembly including a washer and bolt assembly utilizing a conventional nut or bolt would, however, be more desirable, particularly from a cost standpoint.

Another problem associated with a fastener and washer assembly, wherein the fastener is rotatably supported on the washer, is that the fastener and washer may have different strength or hardness requirements. For example, the fastener may require heat treatment or a special protective coating and the washer may preferably be formed from a softer metal or without a protective coating. Thus, it would desirable to form the washer and fastener assembly after heat treatment or application of a protective coating to the fastener.

The fastener and washer assembly of this invention achieves these advantages or objects including the use of a conventional nut or bolt and may be assembled after heat treatment or coating of the fastener.

### SUMMARY OF THE INVENTION

The fastener and washer assembly of this invention may include a conventional nut or bolt particularly, but not exclusively, including a conventional commercially available flange nut or flange bolt having a frustoconical flange or skirt portion, thereby significantly reducing the cost. Further, the fastener and washer assembly of this invention may be assembled after heat treatment or application of a protective coating on the fastener.

The fastener and washer assembly of this invention includes a conventional fastener, such as a conventional flange bolt or flange nut, and a washer rotatably supported on the fastener. The washer includes a central flat or planar bearing portion having an opening therethrough and opposed upwardly angled end portions or ears on opposed sides of the bearing portion each having an elongated opening extending generally perpendicular to the axis of the opening through the central planar portion which receive the flange or skirt portion of the nut or bolt. The ears are preferably angled relative to the planar bearing portion at an angle of less than 90 degrees, preferably between 30 and 85 degrees, and more preferably between 40 and 80 degrees. The ears may also be bowed outwardly to permit greater movement of the washer relative to the fastener for alignment purposes.

The method of assembling the fastener and washer assembly of this invention includes forming a flat generally rectangular washer having a central opening and elongated generally parallel openings on opposed sides of the central opening. The ear portions are then formed by bending the plate adjacent the juncture of the elongated openings at an angle of less than 90 degrees or preferably between 30 and 85 degrees, such that the openings are aligned with the flat central bearing portion of the washer.

The fastener, such as a conventional flange nut or flange bolt, is then assembled on the washer by driving the flange or skirt portion of the nut or bolt against at least one of the upwardly angled ear portions and snapped in place. Thus, the method of assembling a fastener and washer assembly of this invention may also include pretreatment of the fastener, such as heat treatment or application of a protective coating. In the one preferred embodiment of the washer, the elongated slots on opposed sides of the central opening include an arcuate or semi-circular inner wall providing additional bearing support for the fastener and providing semi-circular surfaces which support a conventional flange nut or flange bolt, but permits lateral movement toward and away from the end portions.

In a preferred embodiment of the fastener and washer assembly, the fastener includes a polygonal body portion and a frustoconical radial flange portion integral and coaxially aligned with the polygonal body portion. Where the fastener is a female fastener or nut, the female fastener includes a bore through the polygonal body portion and the frustoconical flange portion which may internally threaded as required. Where the fastener is a male fastener, such as a stud, the male fastener may include a shank portion integral with the radial flange portion which may be externally threaded as required. As described above, the washer assembled on the fastener includes a planar bearing portion having a central opening, preferably a cylindrical opening, and generally parallel openings or slots on opposed sides of the central opening equally spaced from the central opening and inclined end portions or ears on opposed ends of the planar bearing portion, wherein the ears are bent upwardly from the planar bearing portion through the slot to receive the frustoconical radial flange portion of the fastener through the slots during assembly. In a preferred embodiment, the inner wall of the elongated slots adjacent the central opening is semi-circular providing full bearing support for the circular radial flange portion of the fastener. Thus, the washer is rotatably supported on the fastener and the fastener can freely rotate relative to the washer during threaded attachment of the fastener. As will be understood, a female fastener will normally be threaded onto a male fastener typically located on the other side of a substrate, such as a bracket or other part. Similarly, a male fastener, such as a bolt, will typically be threaded into a female fastener, such as a nut, again typically on the opposite side of the substrate, such that the washer will bear against the substrate during threading of the fastener.

As will be understood by those skilled in this art, various modifications may be made to the disclosed embodiments of the washer, fastener and washer and fastener assembly within the purview of the appended claims. The embodiments of the fastener and washer assembly and method of forming a fastener and washer assembly disclosed herein are for illustrative purposes only.

### BRIEF DESCRIPTION OF THE DRAWINGS

FIG. 1A is a top view of one embodiment of a washer blank prior to forming the ears;

FIG. 1B is a top view of an alternative embodiment of a washer blank;

FIG. 2A is a top view of the washer blank shown in FIG. 1A following forming of the ears from the blank;

FIG. 2B is a side view of the washer after forming the ears from the blank shown in FIG. 1B;

FIG. 3 is a perspective view of the washer shown in FIG. 2A;

FIG. 4 is an end view of one embodiment of a nut and washer assembly of this invention;

FIG. 5 is a top view of the nut and washer assembly shown in FIG. 4;

FIG. 6 is a side view of the nut and washer assembly shown in FIGS. 4 and 5;

FIG. 7 is a perspective view of the nut and washer assembly shown in FIGS. 4 to 6;

FIG. 8 is a side view of the nut and washer assembly shown in FIGS. 4 to 7 during assembly of the nut and washer assembly;

FIG. 9 is a side view of one embodiment of a bolt and washer assembly of this invention;

FIG. 10 is a top view of the bolt and washer assembly shown in FIG. 9;

FIG. 11 is a side view of FIG. 10;

FIG. 12 is a perspective view of the bolt and washer assembly shown in FIGS. 9 to 11; and

FIG. 13 is a side view of the bolt and washer assembly shown in FIG. 11 during assembly of the washer on the bolt illustrating the method of assembly.

### DESCRIPTION OF THE PREFERRED EMBODIMENTS

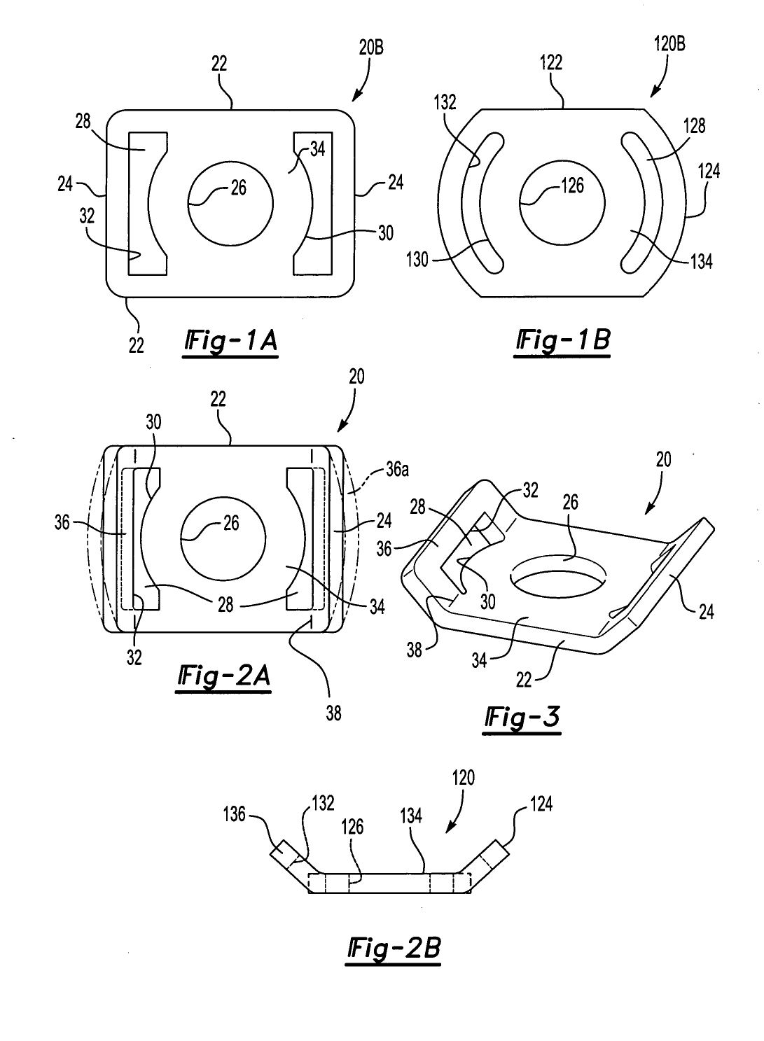

FIG. 1A illustrates one preferred embodiment of a flat rectangular washer blank 20B having linear or planar side faces 22 and linear or planar end faces 24. The rectangular washer blank 20B further includes a central circular opening 26 spaced generally equally between the side faces 22 and the end faces 24. The washer blank 20B also includes elongated generally parallel openings or slots 28 on opposed sides of the central opening 26 adjacent the side faces 24 equally spaced from the central opening 26 and extending perpendicular to the axis of the central opening 26. In this embodiment, the elongated openings 28 each include a curvilinear inner side wall 30, which are generally semi-circular, providing a flat generally circular bearing face 34 as described further below. The elongated openings 28 in this embodiment may also include linear outer side walls 32. The embodiment of the washer blank 120B in FIG. 1B is also generally rectangular and includes linear side faces 122, but the end faces 124 are curvilinear or generally semi-circular each having an axis coincident with the circular center opening 126, such that the elongated openings 128 on opposed sides of the central opening 126 are also generally semi-circular having a curvilinear or generally circular inner side wall 132 and a generally semi-circular outer side wall 132. That is, the nut blank 120B in FIG. 1B is similar to the nut blank 20B shown in FIG. 1A except that the end faces 124 are generally semi-circular and the elongated openings 128 are also semi-circular.

FIGS. 2A and 3 illustrate the washer 20 after forming the ears on washer blank 20B shown in FIG. 1A. As shown in FIG. 2A, the end faces 24 have been deformed upwardly at an angle relative to the flat bearing face 34 of less than 90 degrees and preferably between 30 and 85 degrees, or more preferably between 40 and 80 degrees. As best shown in FIG. 3, the end portions 36 are bent upwardly about a linear axis 38 which is generally coincident with the ends of the semi-circular inner side walls 30, such that the generally circular bearing face 34 remains flat. The washer 120 is similarly formed, such that the end portions 136 are planar and deformed upwardly at an angle of less than 90 degrees relative to the bearing face 134, as described above in regard to FIG. 2A, except that the end faces 124 are generally semi-circular as described above in regard to FIG. 1B.

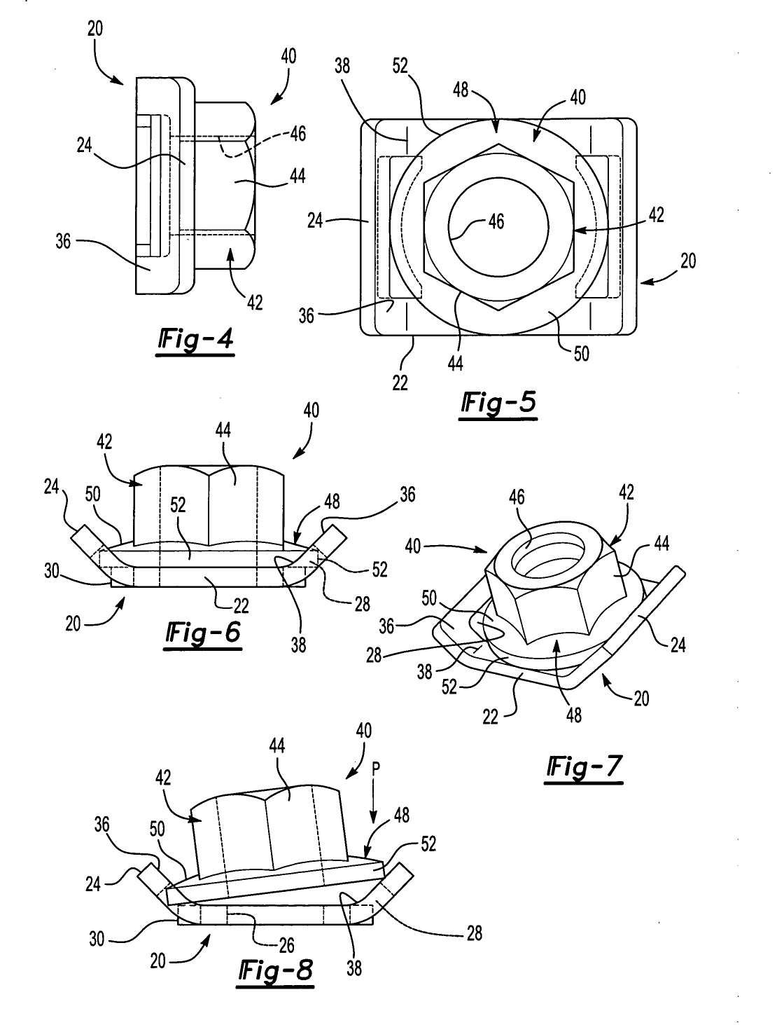

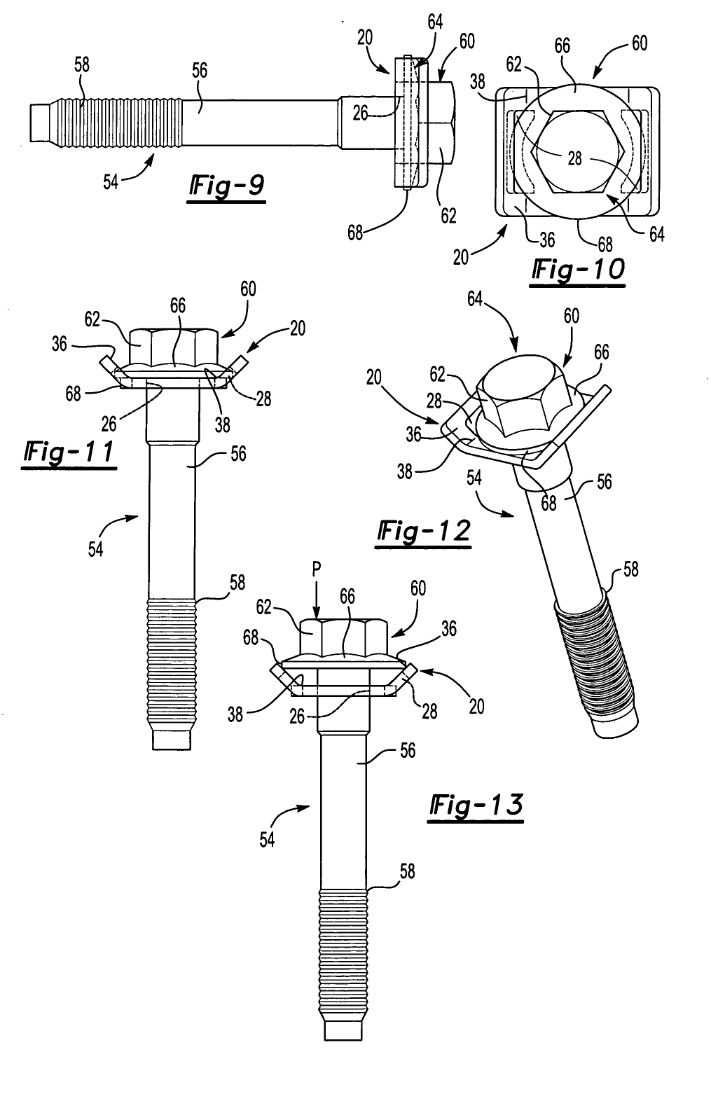

FIGS. 4 to 7 illustrate a nut and washer assembly of this invention, wherein the washer 20 is assembled on a conventional flange nut 40. As will be understood by those skilled in this art, a conventional flange nut 40 includes a body portion 42 having a polygonal outer surface 44, typically hexagonal, as shown, or octagonal, a threaded opening 46 and a radial flange or skirt portion 48 having a frustoconical outer surface 50 and a circular or cylindrical rim portion 52. Although the fastener and washer assembly of this invention is not limited to a conventional flange nut or flange bolt (shown in FIGS. 9 to 13), one important object of this invention is to utilize a conventional nut or bolt of the type commonly used in mass production applications, such as the automotive industry, to reduce costs and to meet the existing specifications of such manufacturers.

As shown in FIG. 8, the washer 20 is assembled on the flange nut 40 by receiving the radial flange or skirt portion 48 into one of the elongated openings 28 and the radial flange portion is then snapped into the opposed elongated opening 28 by a force shown by arrow P which may be applied by hand or preferably by a press. As set forth above, the female fastener and washer assembly shown in FIGS. 4 to 7 will typically be threaded on a male fastener which extends through an opening in a substrate, such as a bracket, wherein the washer 20 is supported on the substrate and the nut is threaded on a threaded portion of a male fastener (not shown). Similarly, the bolt and washer assembly shown in FIGS. 9 to 12 described below is typically received through an opening in a substrate and a nut or other female fastener is threaded onto the end of the bolt, wherein the washer 20 is received against the substrate. Upon assembly, the central opening 26 of the washer 20 may be coaxially aligned with the threaded opening 46 of the washer 20, as shown in FIG. 6, and the flange nut 40 is free to rotate relative to the washer. The radial flange or skirt portion 48 of the nut 40 is received on the flat semi-circular bearing surface 34 of the washer 20, shown in FIGS. 2A and 3, providing an enlarged bearing area which fully supports the radial skirt or flange portion 48 of the nut 40. The flange nut 40 is also free to move laterally toward and away from the upwardly angled end or ear portions 36 because the slots formed by the elongated openings 28 have a width greater than the minor diameter of the frustoconical outer surface 50.

FIGS. 9 to 12 illustrate a bolt and washer assembly of this invention, wherein the washer 20 is assembled on a conventional flange bolt 54. As will also be understood by those skilled in this art, a conventional flange bolt 54 includes an elongated shank portion 56, which is typically externally threaded as shown at 58, and a head portion 60, which is substantially identical to the flange nut 40 described above. That is, the head portion 60 includes a polygonal outer surface 62 and a radial flange or skirt portion 64. The skirt portion 64 typically includes a frustoconical surface 66 and a circular or cylindrical rim portion 68. As described above with regard to FIG. 8, the washer 20 is assembled on the flange bolt 54 by driving the skirt portion 66 as shown by arrow P, which snaps the skirt portion 66 into the elongated openings 28 of the washer. That is, the force P causes the angled end portions 36 to spread or deflect radially outwardly, receiving the flange portion 66 into the elongated openings 28. In this embodiment, the shank portion 56 is first received through the central opening 26 prior to snapping the washer 20 on the flange bolt 54. The semi-circular flat bearing surface 34 shown in FIGS. 2A and 3 similarly supports the radial flange or skirt portions 64 as described above.

As will be understood by those skilled in this art, a conventional or typical flange nut is formed of carbon steel, such as ASTM A563M, which is typically heat treated. A conventional flange bolt is also generally formed of steel, such as ASTM F568M or SAE J1199 and heat treated to Rockwell 42 to 48. The flange nut or flange bolt may then be coated with a protective coating, such as a zinc coating or a black oxide. A flange nut or flange bolt is then threaded onto a bolt in the nut and washer assembly of this invention or into a threaded opening in the bolt and washer assembly of this invention. In mass production applications, the fastener is typically threaded using a conventional torque wrench set at about 1370 in./lbs. With the method of forming a fastener and washer assembly of this invention, the flange nut or flange bolt may be heat treated and coated to the manufacturer's specifications and then assembled on the washer of this invention by simply snapping the washer in place as described above. However, the fastener will freely rotate on the washer following assembly. As will now be understood, the inclination of the end portions 36 of the washer is preferably less than 90 degrees to permit the washer to be snapped on the fastener. However, the angle of inclination should be greater than 40 degrees and less than 90 degrees to assure that the washer remains on the fastener and the washer may be snapped in place on the fastener.

Having described preferred embodiments of the fastener and washer assembly and a method of assembly, it will be understood by those skilled in this art that various modifications may be made within the purview of the appended claims. For example, end portions 36 may be bowed outwardly as shown in phantom at 36A in FIG. 2A to provide greater clearance. Further, the opening 26 may be elongated toward the end faces 24 to accommodate misalignment. The washer may also be welded to the substrate by providing conventional weldable dimples (not shown) on the flat bearing portion opposite the fastener preferably adjacent the end faces. The washer 20 is preferably formed of steel, such as SAE 1050 or 1065, but is preferably not heat treated.

1. A fastener and washer assembly, comprising:
a washer including a flat bearing portion, a central opening through said bearing portion, and end portions inclined from a plane of said bearing portion including elongated openings on opposed sides of said central opening, and a fastener having a body portion and a radial flange portion received in said elongated openings retaining said washer on said fastener, whereby said fastener is free to rotate relative to said washer.

2. The fastener and washer assembly as defined in claim 1, wherein said end portions are inclined relative to said bearing portion at an angle of less than 90 degrees.

3. The fastener and washer assembly as defined in claim 1, wherein said washer includes side faces and end faces and said elongated openings are generally parallel to said end faces.

4. The fastener and washer assembly as defined in claim 1, wherein said elongated openings each include a generally semi-circular inner side wall adjacent said central opening.

5. The fastener and washer assembly as defined in claim 3, wherein said central opening is circular and said inner side wall of said elongated openings are generally semi-circular.

6. The fastener and washer assembly as defined in claim 1, wherein said end portions are bent relative to said bearing portion along an axis generally aligned with an outer wall of said elongated openings.

7. The fastener and washer assembly as defined in claim 1, wherein said elongated openings are arcuate including arcuate inner and outer side walls.

8. The fastener and washer assembly as defined in claim 1, wherein said fastener is a female fastener having an axial bore generally coaxially aligned with said central opening of said washer.

9. The fastener and washer assembly as defined in claim 1, wherein said fastener is a male fastener having a shank portion received through said central opening of said washer.

10. The fastener and washer assembly as defined in claim 1, wherein said radial flange portion includes a frustoconical outer surface received in said elongated openings of said washer.

11. A fastener and washer assembly, comprising:
a washer including a planar central bearing portion having a central opening therethrough, generally parallel slots on opposed sides of said central opening equally spaced from said central opening, and opposed end portions inclined relative to said planar central bearing portion bent relative to said planar central bearing portion along an axis extending through said slots; and
a fastener having a body portion received on said planar central bearing portion of said washer and a radial flange portion received through said slots, rotatably supporting said washer on said fastener.

12. The fastener and washer assembly as defined in claim 11, wherein said end portions are inclined relative to said planar central bearing portion at an angle of between 40 and 80 degrees.

13. The fastener and washer assembly as defined in claim 11, wherein said radial flange portion of said fastener includes a frustoconical outer surface.

14. The fastener and washer assembly as defined in claim 11, wherein said slots each include a generally semi-circular inner side wall adjacent said central opening defining a generally semi-circular outer surface of said planar central body portion.

15. The fastener and washer assembly as defined in claim 11, wherein said fastener is a female fastener having a bore therethrough generally coaxially aligned with said central opening of said washer.

16. The fastener and washer assembly as defined in claim 11, wherein said fastener is a male fastener including a shank portion integral with said body portion extending through said central opening of said fastener.

17. A method of forming a fastener and washer assembly, comprising the following steps:
forming a flat washer blank having a central opening and elongated slots on opposed sides of said central opening equally spaced from said central opening;
forming a washer from said washer blank by deforming end portions of said washer blank about a lineal axis adjacent an outer surface of said elongated openings, wherein said end portions are inclined relative to a portion of said washer surrounding said central opening at an angle of less than 90 degrees; and
assembling said washer on a fastener having a body portion and a radial flange portion by driving said radial flange portion against at least one of said end portions of said washer, resiliently biasing said end portions outwardly and receiving said radial flange portion in said elongated openings.

18. The method of forming a fastener and washer assembly as defined in claim 17, wherein said fastener is a female fastener having a bore through said body portion and said flange portion, said method including generally aligning said bore of said female fastener with said central opening of said washer prior to driving said radial flange portion against at least one of said end portions of said washer.

19. The method of forming a fastener and washer assembly as defined in claim 17, wherein said fastener is a male fastener having a shank portion integral with said radial flange portion coaxially aligned with said body portion, said method including receiving said shank portion through said central opening of said washer prior to driving said radial flange portion against said end portions of said washer.

20. The method of forming a fastener and washer assembly as defined in claim 17, wherein said method includes deforming said end portions of said washer blank at an angle of between 40 and 80 degrees relative to a central portion of said washer surrounding said central opening.

21. A method of forming a fastener and washer assembly, comprising the following steps:
forming a washer blank from a flat generally rectangular metal plate by forming a central opening through said plate, forming elongated openings on opposed sides of said central opening and deforming end portions of said metal plate adjacent said elongated openings along an axis generally parallel to an axis of said elongated openings extending along an outer wall of said elongated openings; and
assembling said washer on a fastener having a body portion and a radial flange portion by driving said radial flange portion against at least one of said end portions of said washer, resiliently biasing said end portion outwardly and receiving said radial flange portion in said elongated openings.

22. The method of forming a fastener and washer assembly as defined in claim 21, wherein said method includes forming elongated openings on opposed sides of said central opening having an arcuate inner wall.

23. The method of forming a fastener and washer assembly as defined in claim 21, wherein said method includes forming a washer blank from a flat generally rectangular metal plate having arcuate end surfaces.

24. The method of forming a fastener and washer assembly as defined in claim 21, wherein said fastener is a female fastener having a bore through said body portion and said radial flange portion, said method including generally aligning said bore of said female fastener with said central opening of said washer prior to driving said radial flange portion against said at least one of said end portions of said washer.

25. The method of forming a fastener and washer assembly as defined in claim 21, wherein said fastener is a male fastener having a shank portion integral with said radial flange portion coaxially aligned with said body portion and said radial flange portion, wherein said method includes receiving said shank portion through said central opening of said washer prior to driving said radial flange portion against at least one of said end portions of said washer.
